(19) United States
(12) Patent Application Publication
(10) Pub. No.: US 2011/0276443 A1
(43) Pub. Date: Nov. 10, 2011

(54) MULTI-RESOURCE SERVICES

(75) Inventors: Joanne Saiu, San Jose, CA (US); Purna Prasad Maddukuri, San Ramon, CA (US); Shanti Muppirala, San Jose, CA (US); Tamijselvy Muralidharan, Cupertino, CA (US); Atul Shah, San Ramon, CA (US); Marc Cagigas, Castro Valley, CA (US); June Yee, Orinda, CA (US)

(73) Assignee: Oracle International Corporation, Redwood Shores, CA (US)

(21) Appl. No.: 12/774,061

(22) Filed: May 5, 2010

(51) Int. Cl. G06Q 10/00; G06Q 30/00

(52) U.S. Cl. 705/32; 705/301

(57) ABSTRACT

Embodiments of the invention provide systems and methods for managing multi-resource services. According to one embodiment, a method of managing multi-resource services can comprise creating a requisition for services. The multi-resource requisition can relate to and define an overall project. A multi-resource work order to a selected supplier for the overall project can be generated based on an acceptance and sourcing of the multi-resource requisition. Sourcing of one or more individual services can be performed based on the multi-resource work order. Sourcing can comprise creating a provider work order. The provider work order can relate to and define one instance of the one or more individual services to be provided within the overall project Total costs for the one or more individual services defined by the multi-resource work order can also be subject to a limit on total costs for the overall project defined by the multi-resource work order.

### CROSS-REFERENCES TO RELATED APPLICATIONS

The present application related to U.S. patent application Ser. No. 12/713,382 filed on Feb. 26, 2010 by Saiu et al and entitled “Service Provider Identifiers” which is incorporated herein by reference for all purposes.

### BACKGROUND OF THE INVENTION

Embodiments of the present invention relate generally to methods and systems for managing multi-resource services and more particularly to a tiered model for managing services provided by multiple service providers as part of an overall project.

Businesses in a wide variety of industries commonly rely on contract, contingent, or other temporary workers or service providers to perform various tasks or provide various services in place of or in addition to regular employees. These service providers and the services provided thereby can be managed, for example, via a Supplier Relationship Management (SRM) system. Such an SRM system may be implemented as part of an enterprise solution or other software package executed on one or more servers or other computer systems operated by the business.

However, these systems do not provide for managing services provided by multiple service providers as part of an overall project. For example, current systems do not provide for sourcing or staffing service providers and reporting time and expense of those service providers as part of an overall project while applying budgetary constraints defined for the overall project to the time and expenses of the individual service providers. Hence, there is a need for improved methods and systems for managing multi-resource services.

### BRIEF SUMMARY OF THE INVENTION

Embodiments of the invention provide systems and methods for managing multi-resource services. According to one embodiment, a method of managing multi-resource services can comprise creating a requisition for services. The multi-resource requisition can relate to and define an overall project. In some cases, an approval of the multi-resource requisition by a approver of the overall project can be obtained and a bid from each of one or more suppliers based on the multi-resource requisition can be received. A supplier can be selected from the one or more suppliers based on the bids.

A multi-resource work order to the selected supplier for the overall project can be generated based on an approved and sourced multi-resource requisition. The multi-resource work order may have one or more individual services. Sourcing of individual services comprises the selecting of one or more service providers for one or more individual services in the multi-resource work order. Once a service provider is selected a provider workorder, that is a child of the multi-resource workorder, may be created for the individual service and the new service provider. In addition, the multi-resource work order can be updated based on the selected one or more service providers. Total costs for the individual services in the provider work order can also be subject to a limit on total costs defined by the multi-resource work order.

In some cases, one or more individual services can be added to the multi-resource work order after sourcing the one or more individual services. Adding the one or more individual services can comprise updating the multi-resource work order based on the added individual services subject to the limit on total costs for the overall project as originally defined in the multi-resource work order. One or more service providers for the added individual services can be selected based on the updated multi-resource work order, with a related provider work order created for each. The multi-resource work order can be updated based on the selected one or more service providers for the added individual services.

A report of a time entry or an expense for at least one of the one or more service providers can be received. The time entry or expense can be validated against the limit on total costs defined by the multi-resource work order. If validated, an invoice for the overall project can be generated that includes the validated time entry or expense.

According to another embodiment, a system can comprise a processor and a memory communicatively coupled with and readable by the processor. The memory can have stored therein a series of instructions which, when executed by the processor, cause the processor to create a multi-resource requisition for services. The multi-resource requisition can relate to and define an overall project. A multi-resource work order to the selected supplier for the overall project can be generated based on an acceptance and sourcing of the multi-resource requisition. Sourcing can comprise selecting one or more service providers for the one or more individual services based on the multi-resource work order, and the multi-resource work order can be updated based on the selected one or more service providers. Sourcing of one or more individual services can be performed from the multi-resource work order. Sourcing can further comprise creating a provider work order. The provider work order can relate to and define one instance of the one or more individual services to be provided within the overall project. Total costs for the one or more services defined by the provider work orders can also be subject to a limit on total costs for the overall project defined by the multi-resource work order.

In some cases, one or more individual services can be added to the multi-resource work order after sourcing the one or more individual services. Adding the one or more individual services can comprise updating the multi-resource work order based on the added individual services and creating related provider work orders, subject to the limit on total costs for the overall project defined by the multi-resource work order. One or more service providers for the added individual services can be selected based on the updated multi-resource work order, with a related provider work order created for each. The multi-resource work order can be updated based on the selected one or more service providers for the added individual services.

A report of a time entry or an expense for at least one of the one or more service providers can be received. The time entry or expense can be validated against the limit on total costs defined by the multi-resource work order. If validated, an invoice for the overall project can be generated that includes the validated time entry or expense.

According to yet another embodiment, a machine-readable medium can have stored thereon a series of instructions which, when executed by a processor, cause the processor to manage multi-resource services by creating a multi-resource requisition for services. The multi-resource requisition can relate to and define an overall project. In some cases, an approval of the multi-resource requisition by an approver of the overall project can be obtained and a bid from each of one or more suppliers based on the multi-resource requisition can be received. A supplier can be selected from the one or more suppliers based on the bids.

A multi-resource work order to the selected supplier for the overall project can be generated based on an acceptance and sourcing of the multi-resource requisition. Sourcing of one or more individual services can be performed based on the multi-resource work order. Sourcing can comprise selecting one or more service providers for the one or more individual services based on the multi-resource work order and the multi-resource work order can be updated based on the selected one or more service providers. Sourcing can further comprise creating a provider work order. The provider work order can relate to and define one instance of the one or more individual services to be provided within the overall project Total costs for the one or more individual services defined by the multi-resource work order can also be subject to a limit on total costs for the overall project defined by the multi-resource work order.

In some cases, one or more individual services can be added to the multi-resource work order after sourcing the one or more individual services. Adding the one or more individual services can comprise updating the multi-resource work order based on the added individual services and creating related provider work orders, subject to the limit on total costs for the overall project defined by the multi-resource work order. One or more service providers for the added individual services can be selected based on the updated multi-resource work order, with a related provider work order created for each. The multi-resource work order can be updated based on the selected one or more service providers for the added individual services.

A report of a time entry or an expense for at least one of the one or more service providers can be received. The time entry or expense can be validated against the limit on total costs defined by the multi-resource work order. If validated, an invoice for the overall project can be generated that includes the validated time entry or expense.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for managing multi-resource services according to one embodiment of the present invention.

FIG. 4 is a flowchart illustrating a process for multi-resource sourcing as may be performed by a Supplier Relationship Management (SRM) system according to one embodiment of the present invention.

FIG. 5 is a flowchart illustrating a process for updating a multi-resource work order after sourcing according to one embodiment of the present invention.

FIG. 6 is a flowchart illustrating additional details of a process for multi-resource service sourcing according to one embodiment of the present invention.

FIG. 7 is a flowchart illustrating a process for time reporting as may be performed by a Supplier Relationship Management (SRM) system according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for a tiered model for managing services provided by multiple service providers as part of an overall project. More specifically, embodiments of the present invention provide for sourcing or staffing service providers and reporting time and expense of those service providers as part of an overall project while applying budgetary constraints defined for the overall project to the time and expenses of the individual service providers. To achieve this, the tiered model includes generating a multi-resource requisition at one tier that relates to and defines the overall project, including a total cost limit for the overall project. A second tier of this model can be related to and define individual services to be provided by one or more service providers as part of the overall project. Both tiers can be used to generate multi-resource work orders to suppliers selected for the project. Time and expense entries for the various service providers can be entered and recorded for the individual services on the second tier but validated and invoiced against the first tier so that the total cost limit for the overall project can be enforced.

Stated another way, embodiments of the invention provide systems and methods for managing multi-resource services. According to one embodiment, managing multi-resource services can comprise creating a multi-resource requisition for services. The requisition can relate to and define an overall project. A multi-resource work order to a selected supplier for the overall project can be generated based on an acceptance and sourcing of the multi-resource requisition. Sourcing of the overall multi-resource service can be performed based on the multi-resource requisition, resulting in the creation of a related multi-resource work order. Sourcing can also comprise creating a provider work order. The provider work order can relate to and define one instance of the one or more individual services to be provided within the overall project Total costs for the one or more individual services defined by the provider work orders can also be subject to a limit on total costs for the overall project defined by the multi-resource work order. Various additional details of embodiments of the present invention will be described below with reference to the figures.

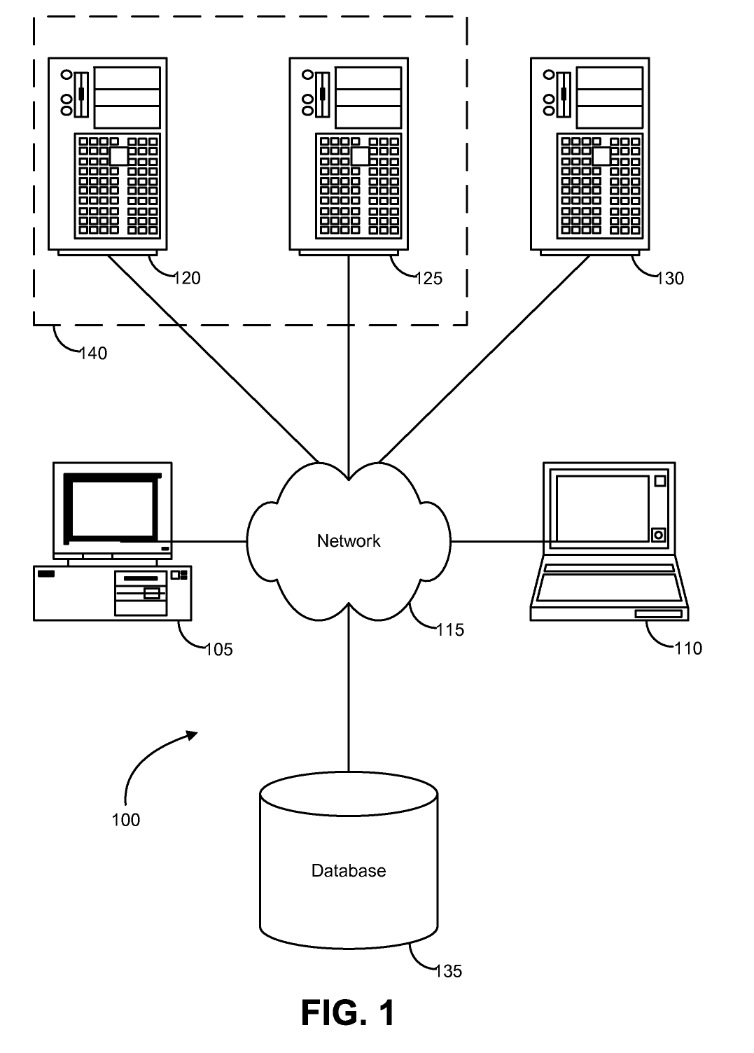

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

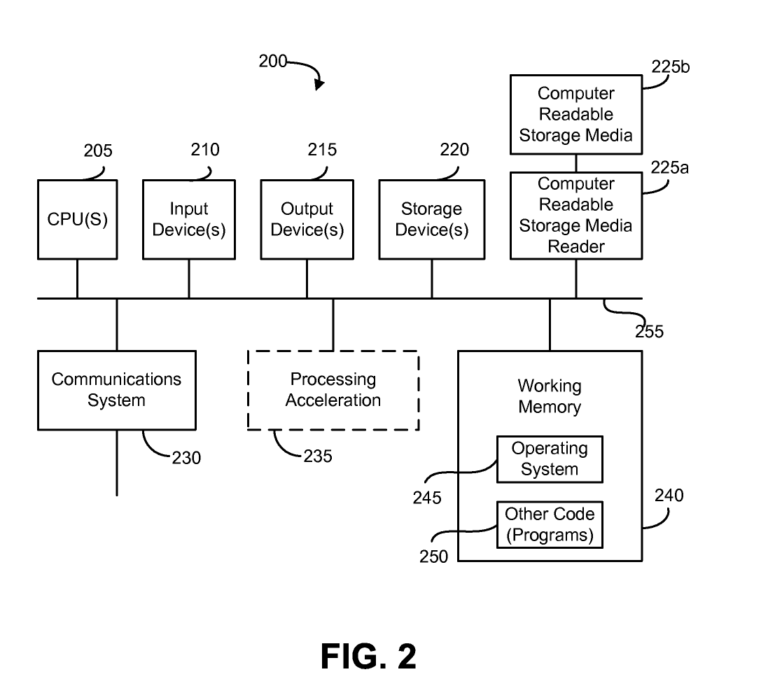

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

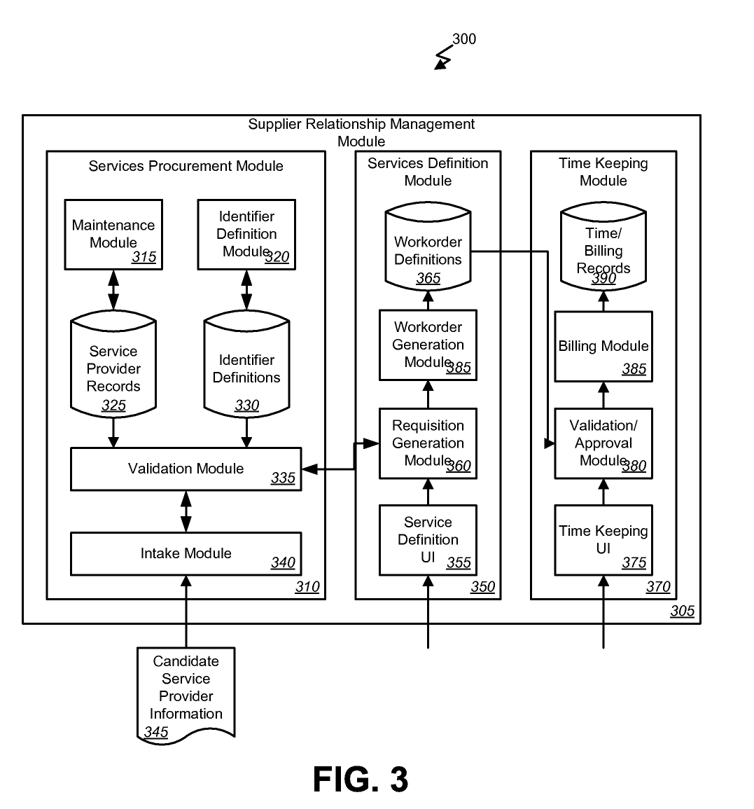

FIG. 3 is a block diagram illustrating, at a high-level, functional components of a system for managing multi-resource services according to one embodiment of the present invention. In this example, the system 300 can include a Supplier Relationship Management (SRM) module 305 or system as may be part of an enterprise solution executed on a client or server as described above. As illustrated here, the SRM module 305 can include a services definition module 350 comprising, for example, a service definition user interface 355, a requisition generation module 360, a work order generation module 385 and a work order definitions repository 365.

As noted above, embodiments of the invention provide systems and methods for a tiered model for managing services provided by multiple service providers as part of an overall project. More specifically, embodiments of the present invention provide for sourcing or staffing service providers and reporting time and expense of those service providers as part of an overall project while applying budgetary constraints defined for the overall project to the time and expenses of the individual service providers. To achieve this, the requisition generation module 360, for example in response to information and/or instructions from a user via service definition user interface 355, can generate a multi-resource requisition which in turn triggers generation of a multi-resource order at one tier that relates to and defines the overall project, including a total cost limit for the overall project. The requisition generation module 360 can also generate a second tier of this model. This second tier can be related to and define individual services to be provided by one or more service providers as part of the overall project. Both tiers can be used by work order generation module 385 to generate the related multi resource work order to a supplier selected for the project. The work order generation module 385 can also generate one or more provider work orders for instances of the one or more individual services defined on the multi-resource work order. The work orders may be saved, for example, in work order definition repository 365. It should be noted that while illustrated here as part of or within the SRM module 310, such an arrangement is not required. Rather, the repository 365 may be external to yet accessible by the SRM module 310. Any such variations in implementation are considered to be within the scope of the present invention.

As noted above, sourcing of one or more individual services can be performed based on the multi-resource work order. Sourcing can comprise work order generation module 385 creating a provider work order. The provider work order can relate to and define one instance of the one or more individual services to be provided within the overall project. Total costs for the one or more individual services defined by the provider work orders can also be subject to a limit on total costs for the overall project defined by the multi-resource work order.

According to one embodiment, sourcing can be performed by requisition module 360 based on or in cooperation with a services procurement module 310 of SRM module 305. The services procurement module 310 that can be adapted to source one or more service providers for services identified by the multi-resource work order, for example, according to the systems and methods described in the Related Application entitled “Service Provider Identifiers” which is cross referenced above and incorporated herein by reference. As described therein, the services procurement module 310 can include an identifier definition module 320 that can be used to define a set of identifiers for information related to service providers. For example, the identifier definition module 320 can provide a user interface through which a set of identifiers can be defined which indicate which information related to the candidate service provider will be used to validate the candidate service provider.

The identifier definition module 330 can be communicatively coupled with a repository 330 in which the identifier definitions can be stored. It should be noted that while illustrated here as part of or within the SRM module 310, such an arrangement is not required. Rather, the repository of identifier definitions 330 may be external to yet accessible by the SRM module 310. Any such variations in implementation are considered to be within the scope of the present invention.

The service procurement module 310 can also include a maintenance module 315. The maintenance module 315 can be communicatively coupled with a repository 325 in which service provider information can be stored. It should be noted that while illustrated here as part of or within the SRM module 310, such an arrangement is not required. Rather, the repository of service provider information 325 may be external to, yet accessible by, the SRM module 310. Any such variations in implementation are considered to be within the scope of the present invention. Regardless of the exact implementation, the maintenance module 315 can be adapted to define and/or maintain records of service provider information in the repository of service provider records 325.

As noted in the Related Application, a determination can be made as to whether a service provider submitted for a new assignment has been previously identified as eligible or ineligible for new assignments. More specifically, service procurement module 310 provides for identifying service providers who should not be used again and recognize attempts to submit that service provider or a service provider with similar identifying information in the future. Accordingly, identifier definitions 330 can be defined, e.g., through identifier definition module 320, which indicate which information related to a candidate service provider will be used to validate the candidate service provider.

Information for the candidate service provider 345 can be received at the SRM system 305, for example, via intake module 340. According to one embodiment, the candidate information 345 can be received through a bidding process. For example, the intake module 340 can provide a bidding process with a user interface through which candidate information can be submitted. Additionally or alternatively, the candidate information 345 can be received through a work order process. For example, the intake module 340 can provide a work order process with a user interface through which candidate information can be submitted.

Regardless of exactly how the candidate information is received, the information for the candidate 345 can be validated, e.g., by validation module 335, against the service provider records 325 based on the identifier definitions 330. That is, the candidate information 345 indicated by the identifier definitions 330 can then be used to search against the service providers records 325. When a potential match is recognized based on the defined identifiers 330 and maintained service provider information 325, a warning can be issued by the validation module 335 and the user, e.g., coordinator or administrator, given an opportunity to determine whether it is an actual match or not and/or update the service provider information, e.g., provide an indication of eligibility or ineligibility. For example, the validation module 335 can provide user interfaces through which various warnings can be provided and updates can be received.

Once service providers have been identified and validated by services procurement module 310, the sourcing and bidding process can add the service providers to the provider work order to be included in the work order generated by work order generation module 385. However, as noted, the service providers and costs associated therewith, e.g., pay, associated expenses, etc., can be subject to a total cost limit defined for the overall project by the multi-resource work order. Thus, request generation module 360 can also apply this limit to totals for the identified service providers as part of a validation process prior to or as part of generating the provider work orders.

As noted above, in some cases, one or more individual services can be added to the multi-resource work order by services definition module 350 after sourcing the one or more individual services. For example, adding the one or more individual services can comprise updating the multi-resource work order saved in work order definition repository 365 based on information and/or instructions for the added individual services from a user received through service definition user interface 355. Again, the added individual services can be subject to the limit on total costs for the overall project defined by the multi-resource work order and applied by work order generation module 385. One or more service providers for the added individual services can be selected by services procurement module 310 as described above based on the updated multi-resource work order. The multi-resource work order can be updated by work order generation module 385 based on the selected one or more service providers for the added individual services.

SRM module 305 can also include time keeping module 370 which can comprise, for example, time keeping user interface 375, validation/approval module 380, billing module 385, and billing records repository 390. Time keeping or billing records or expense reports can be received from service providers, for example via time keeping interface 375. Validation/approval module 380 can determine a current total cost for the overall project, including the received time or expense reports, and validate or confirm these reports against the limit on total costs for the overall project, e.g., from the multi-resource work order stored in work order repository 365. If validated or approved, billing module 385 can use the received time or expense reports to generate an invoice for the overall project which includes the received reports or charges based on information from the received reports. Thus, time and expense entries for the various service providers can be entered and recorded for the provider work order but validated and invoiced against the multi-resource work order so that the total cost limit for the overall project can be enforced.

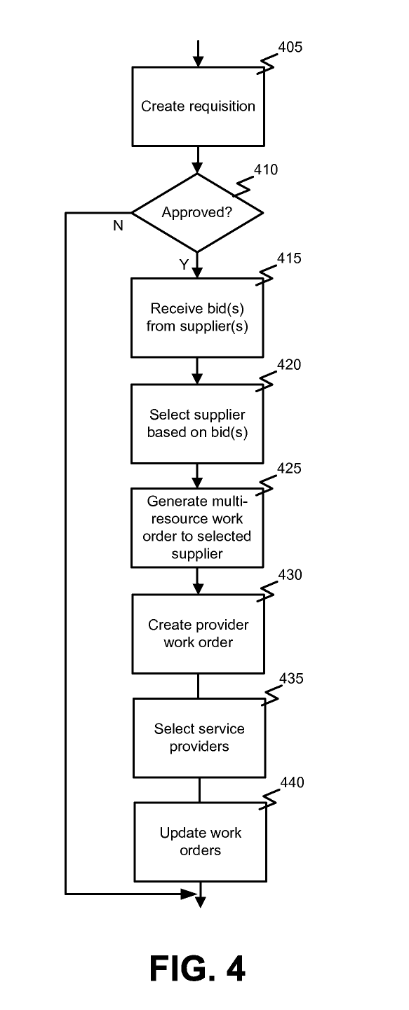

FIG. 4 is a flowchart illustrating a process for multi-resource sourcing as may be performed by a Supplier Relationship Management (SRM) system according to one embodiment of the present invention. In this example, the process can begin with creating 405 a multi-resource requisition for services. The multi-resource requisition can relate to and define an overall project. A determination 410 can be made as to whether the multi-resource requisition is approved. The determination 410 can be based, for example, on receiving an indication of an approval of the requisition by an approver of the overall project. If 410 approved, a bid can be received 415 from each of one or more suppliers based on the multi-resource requisition. A supplier can be selected 420 from the one or more suppliers based on the bids.

A multi-resource work order to the selected supplier for the overall project can be generated 425 based on an acceptance and sourcing of the requisition. Sourcing of one or more individual services can be performed based on the requisition multi-resource work order. Sourcing can comprise creating 430 a provider work order. The provider work order can relate to and define one instance of the one or more individual services to be provided within the overall project Total costs for the one or more individual services defined by the provider work orders can also be subject to a limit on total costs for the overall project defined by the multi-resource work order. Sourcing can further comprise selecting 435 one or more service providers for the one or more individual services based on the multi-resource work order and the multi-resource work order can be updated 440 based on the selected one or more service providers.

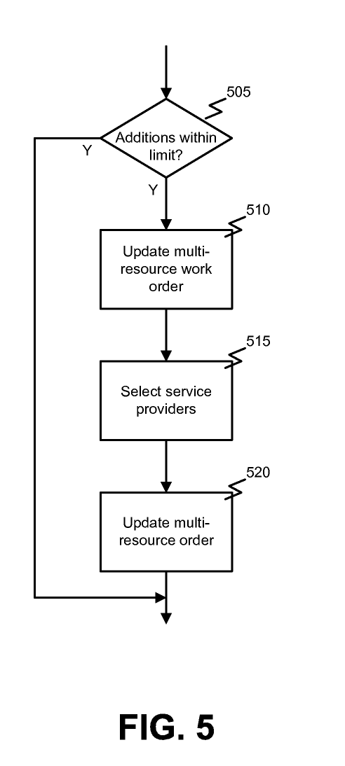

FIG. 5 is a flowchart illustrating a process for updating a work order after sourcing according to one embodiment of the present invention. In some cases as noted above, one or more individual services can be added to the multi-resource work order after sourcing the one or more individual services. In this example, adding the one or more individual services can comprise determining 505 whether the additions are within the limit on total costs defined in the multi-resource work order and updating 510 the multi-resource work order based on the added services if 505 within the limit on total costs for the overall project defined by the multi-resource work order. One or more service providers for the added individual services can be selected 515 based on the updated multi-resource work order, with a related provider work order created for each. The multi-resource work order can be updated 520 based on the selected one or more service providers for the added individual services.

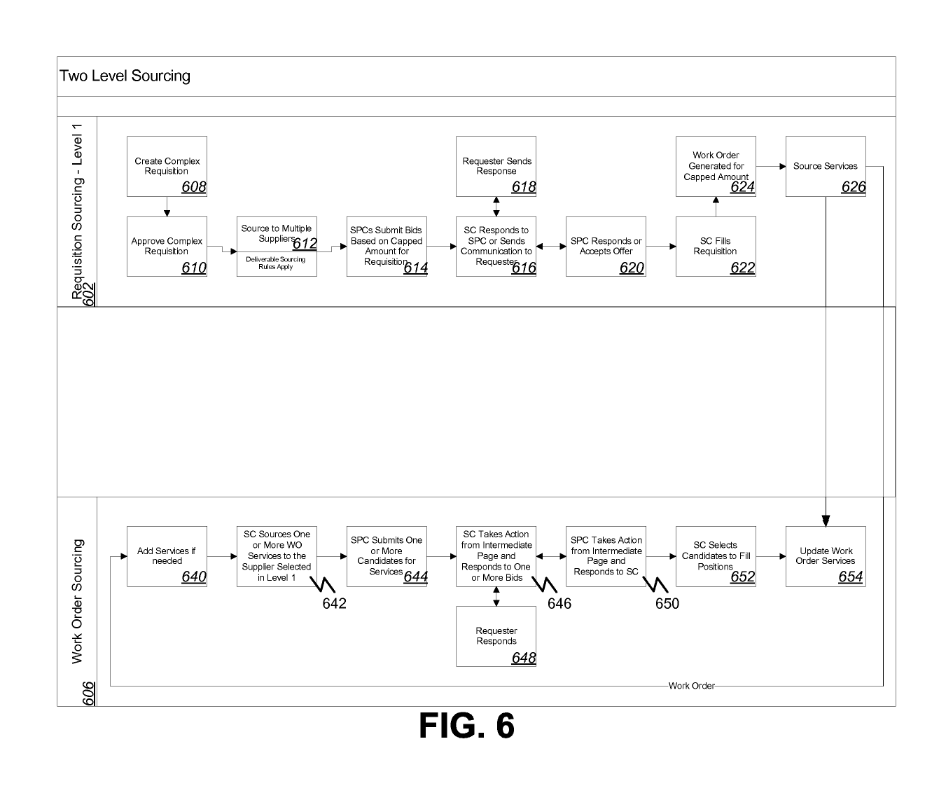

FIG. 6 is a flowchart illustrating additional details of a process for multi-resource service sourcing according to one embodiment of the present invention. As illustrated in this example, the process can begin with creating 608 a multi-resource requisition for a project at a requisition sourcing level 602 as described above. Once the multi-resource requisition is created 608 and approved 610, the multi-resource requisition can be sourced 612 or provided to multiple suppliers, i.e., for bidding etc. Service provider contacts can then submit 614 bids based on the total amount of the project specified by the multi-resource requisition. A service coordinator can then respond 616 to the service provider contacts and/or send communications to the requestor of the project. The requestor can respond 618 to any such communications as can the service provider contact respond 620 and possibly accept an offer for the project. Once accepted by a service provider contact, the service coordinator can fill the 622 the multi-resource requisition which causes a work order, i.e., the multi-resource work order, to be generated 624. Individual services can then be sourced 626 based on this multi-resource work order.

That is, processing can continue at a second, work order sourcing level 606 in which a provider work order can be generated and/or updated 654. Additionally, individual services can be added 640 as needed and as described above. For example, the service coordinator can source 642 one or more work order individual services to the selected service provider. The service provider contact can submit 644 one or more candidates for the individual services and the service coordinator can respond 646 to the submissions or candidates. In some cases, the service coordinator may seek and obtain approval 648 from the requestor for submitted candidates. Additionally or alternatively, the service coordinator may interact with the service provider contact who can respond 650 to service coordinator, i.e., answer questions, provide additional information, etc. Once approved and/or accepted, the service coordinator can select 652 a submitted candidate to fill a position designated by the multi-resource work order, with a related provider work order created, and the multi-resource work order can be updated 654.

It should be understood that, while some of the elements of the exemplary process described here imply interaction with a user or operator of the system, such interaction may not be required. In cases where such interaction or input is utilized, such can be achieved through a graphical, textual, or other user interface of the systems described herein by exchanges through a web page or set of pages, exchanges of emails or other messages, etc. However, it should also be understood that such interfaces and interactions can vary widely depending upon the exact implementation without departing from the scope of the present invention.

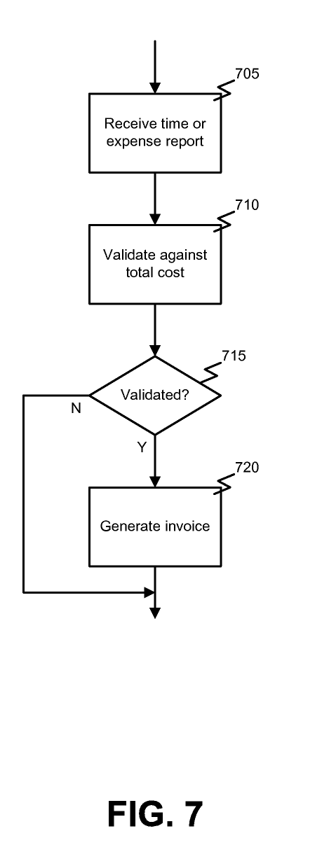

FIG. 7 is a flowchart illustrating a process for time reporting as may be performed by a Supplier Relationship Management (SRM) system according to one embodiment of the present invention. In this example, the process can begin with receiving 705 a report of a time entry or an expense for at least one of the one or more service providers. The time entry or expense can be validated 710 and 715 against the limit on total costs defined by the multi-resource work order. If 715 validated, an invoice for the overall project can be generated 720 that includes the validated time entry of expense.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for managing multi-resource services, the method comprising:
creating with a Supplier Relationship Management (SRM) system a multi-resource requisition for services, wherein the requisition relates to and defines an overall project;
generating with the SRM system a multi-resource work order to a selected supplier for the overall project based on an acceptance and sourcing of the multi-resource requisition; and
sourcing with the SRM system one or more individual services based on the multi-resource work order.

2. The method of claim 1, further comprising obtaining with the SRM system an approval of the multi-resource requisition of the overall project prior to generating the multi-resource work order.

3. The method of claim 1, further comprising receiving with the SRM system a bid from each of one or more suppliers and based on the multi-resource requisition prior to generating the multi-resource work order.

4. The method of claim 3, wherein the selected supplier is selected from the one or more suppliers based on the bids prior to generating the multi-resource work order.

5. The method of claim 1, wherein sourcing comprises creating a provider work order, wherein the provider work order relates to and defines one instance of the one or more individual services to be provided within the overall project, and wherein total costs for the one or more individual services defined by the provider work orders are subject to a limit on total costs for the overall project defined by the requisition.

6. The method of claim 5, wherein sourcing further comprises selecting one or more service providers for the one or more individual services based on the multi resource work order, creating related provider work orders for each, and updating the multi-resource work order based on the selected one or more service providers.

7. The method of claim 6, further comprising adding with the SRM system one or more individual services to the multi-resource work order after sourcing the one or more individual services.

8. The method of claim 7, wherein adding the one or more individual services comprises:
updating the multi-resource work order based on the added individual services and subject to the limit on total costs for the overall project defined by the multi-resource work order;
selecting one or more service providers for the added individual services based one the updated multi-resource work order; creating related provider work orders for each; and
updating the multi-resource work order based on the selected one or more service providers for the added individual services.

9. The method of claim 7, further comprising:
receiving at the SRM system a report of a time entry or an expense for at least one of the one or more service providers;
validating the time entry or expense with the SRM system against the limit on total costs defined by the multi-resource work order; and
generating with the SRM system an invoice for the overall project and including the validated time entry of expense.

10. A system comprising:
a processor; and
a memory, communicatively coupled with and readable by the processor, and having stored therein a series of instructions which, when executed by the processor, cause the processor to create a multi-resource requisition for services, wherein the requisition relates to and defines an overall project, generates a multi-resource work order to a selected supplier for the overall project based on an acceptance and sourcing of the multi-resource requisition, and source one or more individual services based on the multi-resource work order, wherein sourcing comprises creating a provider work order, wherein the provider work order relates to and defines one instance of the one or more individual services to be provided within the overall project, and wherein total costs for the one or more individual services defined by the provider work orders are subject to a limit on total costs for the overall project defined by the multi-resource work order.

11. The system of claim 10, wherein sourcing further comprises selecting one or more service providers for the one or more individual services based on the multi-resource work order and updating the multi-resource work order based on the selected one or more service providers.

12. The system of claim 11, further comprising adding with the SRM system one or more individual services to the multi-resource work order after sourcing the one or more individual services.

13. The system of claim 12, wherein adding the one or more individual services comprises:
updating the multi-resource work order based on the added individual services and subject to the limit on total costs for the overall project defined by the multi-resource work order;
selecting one or more service providers for the added individual services based one the updated multi-resource work order; creating related provider work orders for each; and
updating the multi-resource work order based on the selected one or more service providers for the added individual services.

14. The system of claim 12, further comprising:
receiving at the SRM system a report of a time entry or an expense for at least one of the one or more service providers;
validating the time entry or expense with the SRM system against the limit on total costs defined by the multi-resource work order; and
generating with the SRM system an invoice for the overall project and including the validated time entry of expense.

15. A machine-readable medium having stored thereon a series of instructions which, when executed by a processor, cause the processor to manage multi-resource services by:
creating with a Supplier Relationship Management (SRM) system a multi-resource requisition for services, wherein the requisition relates to and defines an overall project;
generating with the SRM system a multi-resource work order to a selected supplier for the overall project based on an acceptance and sourcing of the multi-resource requisition; and
sourcing with the SRM system one or more individual services based on the multi-resource work order.

16. The machine-readable medium of claim 15, further comprising obtaining with the SRM system an approval of the multi-resource requisition of the overall project prior to generating the multi-resource work order.

17. The machine-readable medium of claim 15, further comprising receiving with the SRM system a bid from each of one or more suppliers and based on the multi-resource requisition prior to generating the multi-resource work order.

18. The machine-readable medium of claim 17, wherein the selected supplier is selected from the one or more suppliers based on the bids prior to generating the multi-resource work order.

19. The machine-readable medium of claim 15, wherein sourcing comprises creating a provider work order, wherein the provider work order relates to and defines one instance of the one or more individual services to be provided within the overall project, and wherein total costs for the one or more individual services defined by the provider work orders are subject to a limit on total costs for the overall project defined by the multi-resource work order.

20. The machine-readable medium of claim 19, wherein sourcing further comprises selecting one or more service providers for the one or more individual services based on the multi-resource work order and updating the multi-resource work order based on the selected one or more service providers.

21. The machine-readable medium of claim 20, further comprising adding with the SRM system one or more individual services to the multi-resource work order after sourcing the one or more individual services.

22. The machine-readable medium of claim 21, wherein adding the one or more individual services comprises:
updating the multi-resource work order based on the added individual services and subject to the limit on total costs for the overall project defined by the multi-resource work order;
selecting one or more service providers for the added individual services based one the updated multi-resource work order; and
updating the multi-resource work order based on the selected one or more service providers for the added individual services.

23. The machine-readable medium of claim 21, further comprising:
receiving at the SRM system a report of a time entry or an expense for at least one of the one or more service providers;
validating the time entry or expense with the SRM system against the limit on total costs defined by the multi-resource work order; and
generating with the SRM system an invoice for the overall project and including the validated time entry of expense.
